(19) United States
(12) Patent Application Publication
(10) Pub. No.: US 2007/0273283 A1
(43) Pub. Date: Nov. 29, 2007

(54) Plasma display panel and method for adjusting color temperature therefor

(75) Inventors: Hung-En Lin, Padeh City (TW); Chih-Ho Lien, Padeh City (TW); Chien-Pang Lee, Padeh City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Padeh City (TW)

(21) Appl. No.: 11/440,346

(22) Filed: May 24, 2006

(51) Int. Cl. H01J 17/49

(52) U.S. Cl. 313/582

(57) ABSTRACT

A plasma display panel and method for adjusting color temperature therefor are provided, including the steps of providing a mixed fluorescent material, a green fluorescent material, and a blue fluorescent material, and then coating the mixed fluorescent material into a rib of each red sub-pixel, coating the mixed fluorescent material into a rib of each green sub-pixel, and coating the blue fluorescent material into a rib of each blue sub-pixel. The red light-emitting portion of the plasma display panel is mixed with a proper amount of the blue fluorescent material so as to achieve a higher color temperature of the red light-emitting portion and thus a higher color temperature of the overall display panel.

### BACKGROUND OF THE INVENTION

1. Field of the Invention

The present invention relates to a plasma display panel and method for adjusting color temperature therefor. More particularly, a mixed fluorescent material is coated into ribs of red light-emitting portions of a rear panel of a plasma display panel.

2. Descriptions of the Related Art

Color temperature can be defined as reactive level of human eyes to a light-emitting body or a white reflective body and is generally determined physically, physiologically, and psychologically. The color temperature may be measured as a temperature to which an ideal black body is heated where the ideal black body emits a light having an identical color to that of the used light source, wherein the temperature is measured by Kelvin temperature scale, ° K.

It is a more convenient and precise method for measuring the color temperature by using a color temperature meter. The color temperature presented from a television (a light-emitting body) or by photography (a light reflection object) may be varied manually. For example, a fluorescent lamp (3,200° K) may be used in photography to control the color temperature of a photographed result. Alternatively, a red filter may be added onto a lens of the camera to filter off some red lights so that the photographed result may have a higher color temperature. As related to a higher color temperature, the photographed result has a bluish and purplish color, called Cold tone. Otherwise, the photographed result has a yellowish and reddish color, called Warm tone.

Whether a higher color temperature of television being good or not is depending on users. For example, TV programs in Taiwan are generally provided with a color temperature of 9,300° K taken with reference to the averaged color temperature of Taiwanese scenery, between 8,000° K and 9,500° K, presented over a whole year. It is, however, not the case in the west countries. In the west countries, a color temperature of 5,600 to 6,500° K is taken in the TV programs with reference to the averaged color temperature of the scenery, 6,000° K, measured within a whole year.

However, a displayer is generally presented with a color temperature shift for some reasons. For example, a plasma display panel specified as having a standard color temperature of 7,300° K may exhibit a lower color temperature, such as only about 5,000 to 6,000° K if it has not been subject to a particular process. Such problem of low color temperature has to be improved and attention has to be paid thereon.

Referring to FIG. 1, a schematic illustration of increasing color temperature of a plasma display panel by adjusting ribs in the prior art is depicted therein. In the plasma display panel, red, green, and blue sub-pixels 11, 12 and 13 therein have a proportion of 1.1:1.0:1.2 in area. When the rib of each of the red, green and blue sub-pixels is adjusted, areas of the sub-pixels are varied. Based on this, an area of each of the blue sub-pixels is enlarged and thus the color temperature of the plasma display panel is improved. However, a precisely controlled sand-blasting process should be utilized in the rib manufacturing process so as to vary the area of the sub-pixel. In this regard, the overall process for manufacture of the plasma display panel involves with considerable difficulty and complexity and is even not cost efficient.

### SUMMARY OF THE INVENTION

It is an object of the this invention to solve the problem of low color temperature encountered in the conventional display panel so that higher quality of picture frame may be provided on the display panel and may visually satisfy a user of the display panel.

To achieve the above object, the present invention provides a plasma display panel, which comprises a plurality of ribs. The ribs are disposed on the inner surface of a rear panel of a display panel. Besides, any two adjacent ribs can be used to define a discharge space and the red, green, and blue subpixels are repeatedly arranged on the discharge spaces. Among which, a mixed fluorescent material is coated on the rib of each red subpixel; a green fluorescent material is coated on the rib of each green subpixel; a blue fluorescent material is coated on the rib of each blue subpixel.

The present invention also provides a method for adjusting color temperature of a plasma display panel having a plurality ribs. The ribs are disposed on the inner surface of a rear panel of a display panel. Besides, any two adjacent ribs can be used to define a discharge space and the red, green, and blue subpixels are repeatedly arranged on the discharge spaces. The method comprises the steps of: coating a mixed fluorescent material on the rib of each red subpixel; coating a green fluorescent material on the rib of each green subpixel; coating a blue fluorescent material on the rib of each blue subpixel.

In the present invention, the red light-emitting portion with low color temperature is mixed with a proper amount of the blue fluorescent material in the condition without interfering the light-emitting characteristics of the red light-emitting portion so as to achieve a higher color temperature of the red light-emitting portion and thus a higher color temperature of the overall display panel.

With execution of the present invention, at least the following efficacies may be obtained: (1) the color temperature is increased by coating the mixed fluorescent material but not by a conventional sand-blasting method through which corresponding light-emitting portions are broadened, and hence a relatively simple and less pricey process may be used. (2) the purpose of obtaining a higher color temperature may be achieved through a simple and efficient manner. (3) the problem occurred with the conventional white balance method by which luminance of the display panel may be reduced since the red fluorescent material having a lower color temperature is used to achieve a higher overall color temperature, may be improved. (4) White balance process conducted in the module process may be replaced and thus the manufacturing steps of the display panel may be reduced.

Other objects, structural features and efficacies of the present invention may become apparent from the description of the preferred embodiments below taken in conjunction with the appended drawings.

### BRIEF DESCRIPTION OF THE DRAWINGS

FIG. 1 shows a schematic illustration of increasing color temperature of a plasma display panel by adjusting ribs in the prior art;

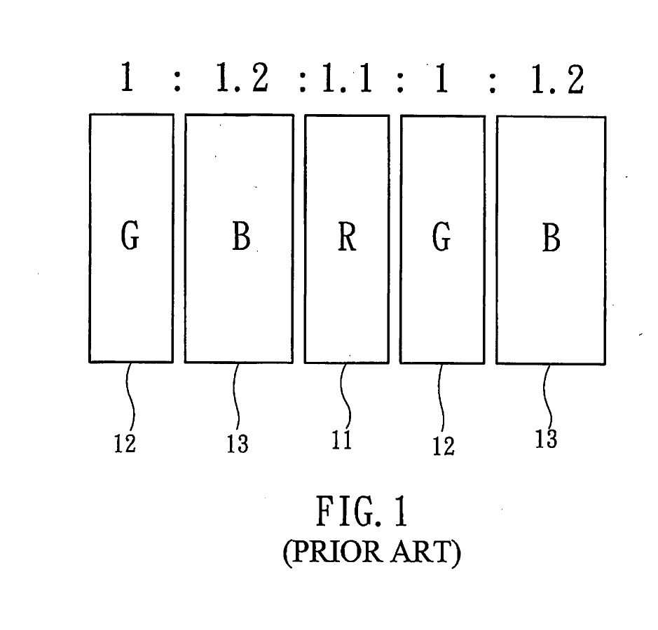

FIG. 2 shows a partial cross sectional view of a plasma display panel manufactured by a method for adjusting color temperature of a plasma display panel according to an embodiment of the present invention; and

FIG. 3 shows a flowchart illustrating the method for adjusting color temperature of a plasma display panel according to the embodiment of the present invention.

### DETAILED DESCRIPTION OF THE INVENTION

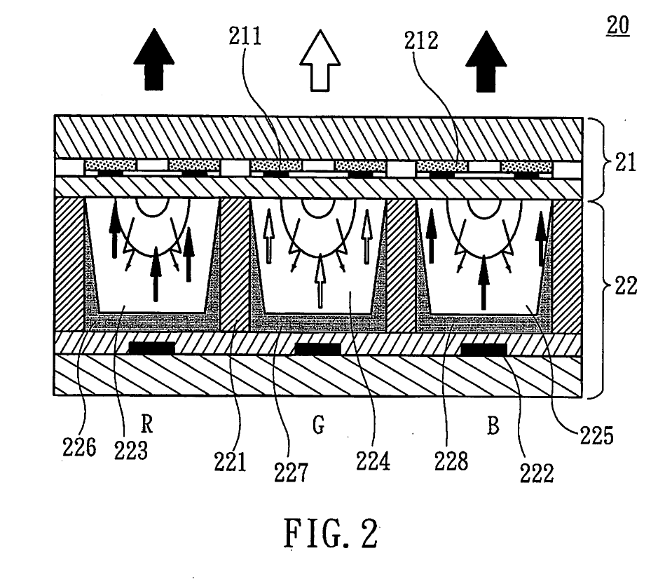

Referring to FIG. 2, a partial cross sectional view of a plasma display panel manufactured by a method for adjusting color temperature of a plasma display panel according to an embodiment of the present invention is shown therein. The plasma display panel 20 (referred to as “display panel” hereinafter) comprises a front plate structure 21 and a rear plate structure 22. The rear plate structure 22 is composed of a plurality of pixels, and each of pixels are composed of a red sub-pixel, a green sub-pixel, and a blue sub-pixel. Each of the red, green, and blue sub-pixels are separated with the adjoining sub-pixels by a rib 221 and thus a discrete red light-emitting portion 223, a discrete green light-emitting portion 224, and a discrete blue light-emitting portion 225 are formed correspondingly.

In addition, green, blue fluorescent materials 227, 228 are coated on the ribs 221 of each green, blue light-emitting portions 224, 225, respectively, but a mixing fluorescent material 226, which is blending a red fluorescent material with the blue fluorescent material, is coated on the ribs 221 of each red light-emitting portion 223. The fluorescent materials are a fluorescent powder. The basis of mixing proportion for the red and blue fluorescent materials is based on the proportion by weight. The proportion of the blue fluorescent material has to account for at least 1% of total or between 1% and 20%, or the mixing fluorescent material has 92% red fluorescent material with 8% blue fluorescent material. The green fluorescent material is made of ZnSiO4: Mn; the blue fluorescent material is made of BaMgAl10O17: EU²⁺; and the red fluorescent material is made of Y2O3: EU³⁺.

By means of the rear plate electrode 222 and a conducting electrode 211 and a transparent electrode 212 of the front plate structure 21, inert gases in the red, green, and blue light-emitting portions 223, 224, 225 are caused to discharge and thus generate ultraviolet rays. Then, the ultraviolet rays excite the mixed fluorescent material 226, the green fluorescent material 227, and the blue fluorescent material 228 in the red, green, and blue light-emitting portions 223, 224, 225, respectively, and thus visible rays, i.e., a red light, a green light, and a blue light, are emitted from the red, green, and blue light-emitting portions 223, 224, 225, respectively.

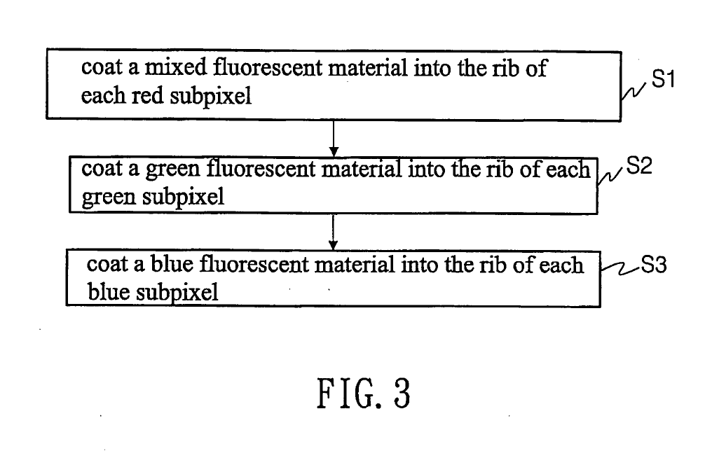

Referring to FIG. 3, a flowchart illustrating the method for adjusting color temperature of the display panel according to the embodiment of the present invention is shown therein. The plasma display panel comprises a plurality of ribs disposed on the inner surface of a rear panel of the plasma display panel. Besides, any two adjacent ribs can be used to define a discharge space and the red, green, and blue subpixels are repeatedly arranged on the discharge spaces. The method comprises the following steps. First, coating a mixed fluorescent material into the rib of each red subpixel (S1). Then, coating a green fluorescent material into the rib of each green subpixel (S2). Finally, coating a blue fluorescent material into the rib of each blue subpixel (S3).

In principle, the red light-emitting portion 223 has the lowest color temperature in the total emitted light among all the light-emitting portions 223, 224, 225 in the conventional display panel. However, in this invention the red light-emitting portion 223 is not only coated with the red fluorescent material. Further, a proper amount of blue fluorescent material is blended in the red fluorescent material as the mixed fluorescent material 226 in the condition without interfering the light-emitting characteristics of the red light-emitting portion 223. Then, the mixed fluorescent material 226 is coated into the rib 221 of the red light-emitting portion 223. As such, the lowest color temperature presented by the red light-emitting portion 223 is increased since the blue fluorescent material also coated into the rib has a greater color temperature, and the overall color temperature of the display panel 20 is increased.

In this embodiment, the mixed, green, and blue fluorescent materials 226, 227, 228 are all in a form of fluorescent powders. As related to a proportion of the red and blue fluorescent materials in the mixed fluorescent material, 92 grams of the red fluorescent material is, for example, mixed with 8 grams of the blue fluorescent material to form 100 grams of the mixed fluorescent material 226 for the specific color temperature 7,300° K.

To acquire various color temperatures, the proportion of the red and blue fluorescent materials blended together in the mixed fluorescent material may be adjusted based thereon as long as the character of red light-emitting of the red light-emitting portion 223 wouldn't be affected. Generally, 1 to 20 grams of the blue fluorescent material 228 may be added in 100 grams of the mixed fluorescent material 226 to achieve requirements of different color temperature specifications. Accordingly, weight percentage (wt %) of the red and blue fluorescent materials in the mixed fluorescent material may be from 99 wt %:1 wt % to 80 wt %:20 wt %. To obtain the mixed fluorescent material, it is only required that the red and blue fluorescent materials be agitated in a general environment without the need of involving a complex process. As such, the mixed fluorescent material may be obtained in a simple and cost efficient manner.

To verify that this embodiment may be practicable and provided with actual improvement, a test is performed thereon with the display panel powered on and thus the light-emitting portions therein emitting lights. Before this test is conducted, the conventional and inventive fluorescent materials are coated into ribs of the red, green and blue light-emitting portions 223, 224 and 225, respectively, of two separate display panels.

| | | Green | Blue |
|---|---|---|---|
| Fluorescent | Red light-emitting | light-emitting | light-emitting |
| materials used | portion 223 | portion 224 | portion 225 |
| Present | 92% KX-504A 50% + | PSS2 40% | NP107-343 |
| invention | 8% NP107-343 30% | | 30% |
| Conventional | KX-504A 50% | PSS2 40% | NP107-343 |
| method | | | 30% |

In this embodiment, the red fluorescent material used for the red light-emitting portion 223 is the product of KX-504A, KASEI OPTONIX LTD of Japan with a weight percentage of 92% and a solid content of 50% and the blue fluorescent material 228 for the red light-emitting portion 223 is the product of NP107-343, NICHIA CORPORATION of Japan with a weight percentage of 8% and a solid content of 30%. The green fluorescent material 227 used for the green light-emitting portion 224 is the product of PSS2, KASEI OPTONIX LTD of Japan with a solid content of 40%. The blue fluorescent material 228 used for the blue light-emitting portion 225 is the product of NP107-343, NICHIA CORPORATION of Japan with a solid content of 30%. On the other hand, in the conventional method, the red fluorescent material used for the red light-emitting portion 223 is the product of KX-504A, KASEI OPTONIX LTD of Japan. with a solid content of 50%. The green fluorescent material for the green light-emitting portion is the product of PSS2, KASEI OPTONIX LTD of Japan with a solid content of 40%. The blue fluorescent material 228 used for the blue light-emitting portion 225 is the product of NP107-343, NICHIA CORPORATION of Japan with a solid content of 30%.

After the fluorescent materials are coated, the display panel 20 is powered on and tested.

| | Luminance of Full White Color W(FF)h | | | | |
|---|---|---|---|---|---|
| | | | | Color | Color |
| | | | Luminance | temperature | deviation |
| Type | x | y | (Y) | (Tc) | (duv) |
| Present | 0.309 | 0.316 | 153.4 | 6850 | −0.002 |
| inventive | | | | | |
| display panel | | | | | |
| The | 0.317 | 0.327 | 153.1 | 6305 | 0 |
| conventional | | | | | |
| display panel | | | | | |

As compared to the conventional single color fluorescent materials, it is found that color temperature of full white color light emitted from the display panel with the inventive mixed fluorescent material 226 coated may be increased with 500° K. Therefore, it may be readily proved that color temperature of the full white color light is actually influenced by the mixed fluorescent material 226.

In order to clearly understand the present invention, the combination of fluorescent materials using in the above embodiment is tabulated as below:

Combination Of Fluorescent Materials

| No. | Blue | Green | Mix |
|---|---|---|---|
| 1 | CaWO₄:Pb | Zn₂SiO₄:Mn | Y₂O₃:Eu³⁺ |
| 2 | Y₂SiO₅:Ce | Zn₂SiO₄:Mn | Y₂O₃:Eu³⁺ |
| 3 | YP_{0.85}V_{0.15}O₄ | Zn₂SiO₄:Mn | YP_{0.85}V_{0.35}O₄:Eu³⁺ |
| 4 | BaMgAl₁₄O₂₃:Eu⁺² | Zn₂SiO₄:Mn | YBO₃:Eu³⁺ |
| 5 | BaMgAl₁₄O₂₃:Eu⁺² | Zn₂SiO₄:Mn | YGd_{0.35}BO₃:Eu³⁺ |
| 6 | BaMgAl₁₄O₂₃:Eu⁺² | BaAl₁₂O₁₀:Mn | YGd_{0.35}BO₃:Eu³⁺ |

The main composition of BaMgAl₁₄O₂₃: Eu⁺² and (Ba,Eu) MgAl₁₀O₁₇ (can also be expressed as BaMgAl₁₀O₁₇: Eu⁺²) are the same, but their chemical formulas are different because of different mixing proportions of containing material.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A plasma display panel having a plurality of ribs which are disposed on the inner surface of a rear panel of said plasma display panel to define a discharge space by any two adjacent ribs, wherein red subpixel, green subpixel, and blue subpixel are repeatedly arranged on said discharge spaces:
a mixed fluorescent material is coated into said rib of each red sub-pixel;
a green fluorescent material is coated into said rib of each green sub-pixel; and
a blue fluorescent material is coated into said rib of each blue sub-pixel.

2. The plasma display panel according to claim 1, wherein said mixed fluorescent material is using a red fluorescent material blending with said blue fluorescent material.

3. The plasma display panel according to claim 2, wherein said red and blue fluorescent materials are blended in said mixed fluorescent material based on a specific weight percentage.

4. The plasma display panel according to claim 3, wherein said blue fluorescent material has a weight percentage of at least 1% in said mixed fluorescent material.

5. The plasma display panel according to claim 3, wherein said blue fluorescent material has a weight percentage of between 1% and 20% in said mixed fluorescent material

6. The plasma display panel according to claim 1, wherein said fluorescent materials are in a form of fluorescent powders.

7. The plasma display panel according to claim 3, wherein said weight percentage is 92% red fluorescent material with 8% blue fluorescent material.

8. The plasma display panel according to claim 1, wherein said red fluorescent material is made of Y2O3: EU³⁺.

9. The plasma display panel according to claim 1, wherein said green fluorescent material is made of ZnSiO4: Mn.

10. The plasma display panel according to claim 1, wherein said blue fluorescent material is made of BaMgAl10017: EU²⁺.

11. The plasma display panel according to claim 1, wherein said blue fluorescent material is selected from the group of CaWO4: Pb, Y2SiO5: Ce, YP0.85V0.15O4, and BaMgAl14O23: Eu⁺².

12. The plasma display panel according to claim 1, wherein said green fluorescent material is selected from the group of Zn2SiO4: Mn and BaAl12O10: Mn.

13. The plasma display panel according to claim 1, wherein said red fluorescent material is selected from the group of Y2O3: Eu³⁺, YP0.85V0.35O4: Eu³⁺, YBO3: Eu³⁺, YGd0.35BO3: Eu³⁺.

14. A method for adjusting color temperature of a plasma display panel, wherein said plasma display panel having a plurality of ribs which are disposed on the inner surface of a rear panel of said plasma display panel to define a discharge space by any two adjacent ribs, red subpixel, green subpixel, and blue subpixel repeatedly arranged on said discharge spaces, comprising the steps of:
coating a mixed fluorescent material into said rib of each red sub-pixel;
coating a green fluorescent material into said rib of each green sub-pixel; and
coating a blue fluorescent material into said rib of each blue sub-pixel.

15. The method according to claim 14, wherein said mixed fluorescent material is using a red fluorescent material blending with said blue fluorescent material.

16. The method according to claim 15, wherein said red and blue fluorescent materials are blended in said mixed fluorescent material based on a specific weight percentage.

17. The method according to claim 16, wherein said blue fluorescent material has a weight percentage of at least 1% in said mixed fluorescent material.

18. The method according to claim 16, wherein said blue fluorescent material has a weight percentage of between 1% and 20% in said mixed fluorescent material.

19. The method according to claim 14, wherein said fluorescent materials are in a form of fluorescent powders.

20. The method according to claim 16, wherein said weight percentage is 92% red fluorescent material with 8% blue fluorescent material.

21. The method according to claim 14, wherein said red fluorescent material is made of Y2O3: EU³⁺.

22. The method according to claim 14, wherein said green fluorescent material is made of ZnSiO4: Mn.

23. The method according to claim 14, wherein said blue fluorescent material is made of BaMgAl10O17: EU²⁺.

24. The plasma display panel according to claim 14, wherein said blue fluorescent material is selected from the group of CaWO4: Pb, Y2SiO5: Ce, YP0.85V0.15O4, and BaMgAl14O23: Eu⁺².

25. The plasma display panel according to claim 14, wherein said green fluorescent material is selected from the group of Zn2SiO4: Mn and BaAl12O10: Mn.

26. The plasma display panel according to claim 14, wherein said red fluorescent material is selected from the group of Y2O3: Eu³⁺, YP0.85V0.35O4: Eu³⁺, YBO 3: Eu³⁺, YGd0.35BO3: Eu³⁺.
